(19) United States
(12) Patent Application Publication
(10) Pub. No.: US 2017/0248062 A1
(43) Pub. Date: Aug. 31, 2017

(54) Power System with First and Second Exhaust Manifolds

(71) Applicant: Deere & Company, Moline, IL (US)

(72) Inventors: Richard E. Winsor, WATERLOO, IA (US); Anton P. Kozlovsky, CEDAR FALLS, IA (US)

(21) Appl. No.: 15/056,213

(22) Filed: Feb. 29, 2016

(51) Int. Cl. F01N 13/10; F02B 37/00; F02B 37/24; F02B 37/18

(52) U.S. Cl. CPC F01N 13/107; F02B 37/183; F02B 37/004; F02B 37/24

(57) ABSTRACT

A power system that includes an engine, a first exhaust manifold, a second exhaust manifold, and a turbine. The first and second exhaust manifolds are positioned downstream of the engine. The turbine is positioned downstream of the first exhaust manifold, but is not positioned downstream of the second exhaust manifold.

### FIELD OF THE DISCLOSURE

The present disclosure relates to a power system with first and second exhaust manifolds. More specifically, the present disclosure relates to a turbine that is positioned downstream of the first exhaust manifold, but not downstream of the second exhaust manifold.

### BACKGROUND OF THE DISCLOSURE

Increasingly stringent emissions regulations have driven many changes in diesel engines, one of which is the widespread use of exhaust gas recirculation systems, wherein exhaust gas from the engine is used as a working fluid diluent to reduce peak combustion temperatures. The formation of oxides of nitrogen (NOₓ) increases exponentially with temperature, so a reduction of the peak temperature through heat transfer to a non-combustible gas mixed with the combustible fuel and air is very effective at reducing NOₓ.

EGR systems have been a mainstay through the first decade of the 21st century to achieve NOₓ reduction in diesel engines, but it also has negative effects. These include increased wear and corrosion in the engine; increased contamination of the oil with soot and acidic materials; increased heat rejection of the engine through heat exchangers, instead of through the exhaust; and increased pumping losses. Careful product development has been able to mitigate these negative effects, but typically with the exception of increased and unwanted pumping losses.

### SUMMARY OF THE DISCLOSURE

Disclosed is a power system having an engine, a first exhaust manifold, a second exhaust manifold, and a turbine. The first and second exhaust manifolds are both positioned downstream of the engine. The turbine is positioned downstream of the first manifold, but not positioned downstream of the second exhaust manifold.

### BRIEF DESCRIPTION OF THE DRAWINGS

The detailed description of the drawings refers to the accompanying figures in which:

FIG. 1 is a simplified schematic illustration of an example power system having an engine, a first exhaust manifold, and a second exhaust manifold; and

FIG. 2 is a simplified schematic illustration of a second example of a power system, but with a different exhaust gas flow path, part of which bypasses the second exhaust manifold.

### DETAILED DESCRIPTION OF THE DRAWINGS

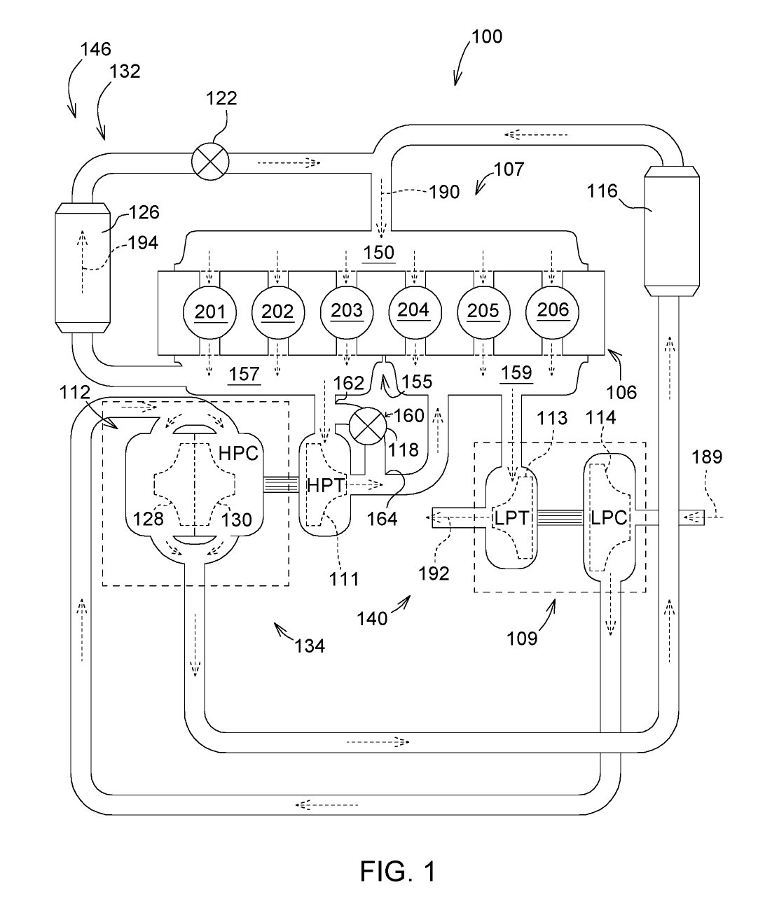

Referring to FIG. 1, there is shown a schematic illustration of a power system 100 for providing power to a variety of machines, including on-highway trucks, construction vehicles, marine vessels, stationary generators, automobiles, agricultural vehicles, and recreational vehicles. The engine 106 may be any kind that produces an exhaust gas (see arrow 192), such as a gasoline engine, a diesel engine, a gaseous fuel burning engine (e.g., natural gas). The illustrated example of the engine 106 includes a first cylinder 201, a second cylinder 202, a third cylinder 203, a fourth cylinder 204, a fifth cylinder 205, and a sixth cylinder 206. Other examples may include greater or fewer cylinders. The engine 106 is shown as an inline-engine, but it may also be a V-engine or a radial engine, to name just a couple of examples.

The power system 100 includes an intake system 107 for introducing fresh intake gas (see arrow 189) to the engine 106, and an exhaust system 140 for directing exhaust gas (see arrow 192) from the engine 106. The intake system 107 may include a low pressure compressor 114, followed by a high pressure compressor 112, followed by a charge air cooler 116, followed by an intake manifold 150. The high pressure compressor 112 compresses the fresh intake gas to an elevated pressure level, while the charge air cooler 116 is positioned downstream of the high pressure compressor 112 for cooling the fresh intake gas. Other embodiments of the intake system 107 may include additional components and/or have the components in different orders (e.g., a charge air cooler positioned fluidly between the low pressure compressor 114 and the high pressure compressor 112).

The exhaust system 140 may include a first exhaust manifold 157 and a second exhaust manifold 159. The first and second exhaust manifolds 157, 159 are both positioned downstream of the engine 106. The first exhaust manifold 157 may be positioned downstream of a portion of the cylinders (e.g., 201-203), and the second exhaust manifold 159 may be positioned downstream of all of the cylinders (e.g., 201-206). In some other embodiments, the first exhaust manifold 157 may be positioned downstream of exactly half of the cylinders (e.g., 201-203), and the second exhaust manifold 159 may be positioned downstream of exactly the other half of the cylinders (e.g., 204-206).

The exhaust system 140 may further include a high pressure turbine 111 followed by a low pressure turbine 113. The high pressure turbine 111 may be positioned so as to be driven only by exhaust gas exiting the first exhaust manifold 157, and the high pressure compressor 112 may be configured so as to be driven by the high pressure turbine 111 via a shaft. The combination of the high pressure turbine 111, the high pressure compressor 112, and the shaft is referred to as the high pressure turbocharger 134. The high pressure compressor 112 may be configured and positioned to compress all fresh intake gas that is eventually combusted in the engine 106.

In the illustrated embodiment of the power system 100, because only cylinders 201-203 feed the high pressure turbine 111, it sees a positive effect of receiving distinct energy pulses from only those cylinders 201-203, instead of receiving distinct energy pulses from all of the cylinders 201-206. These distinct pulses may improve the efficiency and dynamic response of the high pressure turbocharger 134. And further, because only cylinders 201-203 and the first exhaust manifold 157 feed the high pressure turbine 111, it receives the exhaust gas from a smaller volume, which provides less of a dampening effect (as compared to a system in which all cylinders 201-206 feed a single exhaust manifold). This lessened dampening effect may improve the dynamic response of the high pressure turbocharger 134.

The high pressure compressor 112 may include a first impeller 128 and a second impeller 130 positioned fluidly parallel relative thereto. The first impeller 128, the second impeller 130, and the high pressure turbine 111 may be fixed to the shaft, so as to rotate in unison. In some embodiments, the first impeller 128 and the second impeller 130 may be defined by a double-sided compressor 134. The flow rate through the high pressure compressor 112 is typically much larger than the simultaneous flow rate through the high pressure turbine 111. All of the intake gas that is received by the engine 106 flows through the high pressure compressor 112, but only the exhaust gas that exits the first exhaust manifold 157 flows through the high pressure turbine 111.

The first impeller 128 may receive a first portion of the intake gas, while the second impeller 130 may receive a second portion of the intake gas. The first portion and the second portion may be in parallel relative to one another. Splitting the flow into the first and second portions through the first and second impellers 128, 130 helps balance the thrust loads in the high pressure turbocharger 134 (relative to what may be reasonably possible with just a single impeller). The first portion of the intake gas may provide a thrust force directed towards the high pressure turbine 111, while the second portion of the intake gas may provide a thrust force directed away from the high pressure turbine 111. The exhaust gas may provide a thrust force directed towards the high pressure compressor 112. The sum of these thrust forces may be lowered by controlling the flow rates passing by the first and second impellers 128, 130 relative to the flow rate passing by the high pressure turbine 111. And by lowering these thrust forces in this way, the life span of the high pressure turbocharger 134 may be longer than might be the case with a turbocharger with just a single, standard impeller.

The low pressure turbine 113 is driven by exhaust gas exiting the first exhaust manifold 157 and also by exhaust gas exiting the second exhaust manifold 159. The low pressure compressor 114 may be configured to be driven by the low pressure turbine 113 via a shaft. The combination of these components in this position is referred to as a low pressure turbocharger 109. The low pressure compressor 114 may be configured to compress all of the fresh intake gas that is eventually combusted in the engine 106. The combination of the low pressure turbocharger 109 and the high pressure turbocharger 134 may improve turbocharging efficiency with respect to the engine 106, particularly if the engine 106 has a wide speed and load range, and if the high pressure turbocharger 134 is relatively small and the low pressure turbocharger 109 is relatively large.

The power system 100 may include an exhaust gas recirculation (“EGR”) passage 132. The EGR passage 132 may include an EGR cooler 126, an EGR valve 122 positioned downstream thereof, and an EGR mixer positioned downstream thereof—collectively referred to as an EGR system 146. The EGR passage 132 is for receiving a recirculated portion of the exhaust gas (see arrow 194). In contrast, the intake gas (see arrow 190) is a combination of the fresh intake gas (see arrow 189) and the recirculated portion of the exhaust gas (see arrow 194).

The EGR passage 132 is positioned downstream of the first exhaust manifold 157, but not downstream of the second exhaust manifold 159. In engines that include an EGR system 146, the exhaust manifold pressure needs to be higher than the intake manifold 150 pressure, so that the recirculated exhaust gas can flow into and mix with the fresh intake gas. But because of this, engines with EGR systems experience pumping losses, which translates to decreased fuel economy and power levels.

The illustrated EGR system 146 is downstream of only the first exhaust manifold 157. Such positioning confines the pumping losses associated with the EGR system 146 to only the first exhaust manifold 157. With this, only the first exhaust manifold 157 drives the EGR system 146. And in contrast, the second exhaust manifold 159 is thus exposed to much lower exhaust pressures, and its pumping work is entirely dedicated to driving the low pressure turbine 113.

The exhaust system 140 may include a wastegate passage 160 and a wastegate valve 118. In such embodiments, an inlet 162 of the wastegate passage 160 may positioned downstream of the first exhaust manifold 157 and upstream of the high pressure turbine 111. Further, an outlet 164 of the wastegate passage 160 may be positioned downstream of the high pressure turbine 111 and upstream of the second exhaust manifold 159. And still further, the wastegate valve 118 may be positioned downstream of the inlet 162 and upstream of the outlet 164.

The wastegate valve 118 may be closed when the EGR valve 122 is open. In contrast, the wastegate valve 118 may be open when the EGR valve 122 is closed, or close enough thereto, that the pressure in wastegate passage 160 reaches a threshold pressure. By having the wastegate valve 118 open during such conditions, the high pressure turbine 111 does not become overly restrictive to the flow of the exhaust gas. Further, the wastegate valve 118 may be configured to open when an operating pressure in the first exhaust manifold 157 reaches a threshold pressure. Such high pressures may occur at high engine speeds and/or loads.

Other embodiments of the exhaust system 140 may use a balance valve positioned fluidly between the first exhaust manifold 157 and the second exhaust manifold 159, instead of using a wastegate valve 118 downstream of the first exhaust manifold 157. In such embodiments, a balance valve may open and function similarly to the wastegate valve 118.

The pressure ratio of the high pressure turbine 111 may be between 50% and 150% higher than a simultaneous pressure ratio of the high pressure compressor 112. In some embodiments, the pressure ratio of the high pressure turbine 111 may be between 75% and 125% higher than a simultaneous pressure ratio of the high pressure compressor 112. And in yet some other embodiments, the pressure ratio of the high pressure turbine 111 may be between 90% and 110% higher than a simultaneous pressure ratio of the high pressure compressor 112.

To give some specific examples, a pressure ratio of the high pressure turbine 111 may be between 2.5 and 4.5, and a simultaneous pressure ratio of the high pressure compressor 112 may be between 0.5 and 2.5. In some embodiments, a pressure ratio of the high pressure turbine 111 may be between 3 and 4, and a simultaneous pressure ratio of the high pressure compressor 112 may be between 1 and 2. Such imbalances in the pressure ratios may be designed into the high pressure turbocharger 134, so as to deal with the imbalance of the flow rate through the high pressure turbine 111, relative to the simultaneous flow rate through the high pressure compressor 112. Such a design may result in a longer life span of the high pressure turbocharger 134, as a result of the forces therein being more closely balanced.

Though not illustrated, the exhaust system 140 may include an aftertreatment system, and at least a portion of the exhaust gas may pass therethrough. The aftertreatment system may include a diesel oxidation catalyst, a diesel particulate filter, and an SCR system, though the need for such components depends on a number of factors, including the size of the power system 100, the application, and country of market. Exhaust gas that is treated in the aftertreatment system and released into the atmosphere contains significantly fewer pollutants than an untreated exhaust gas.

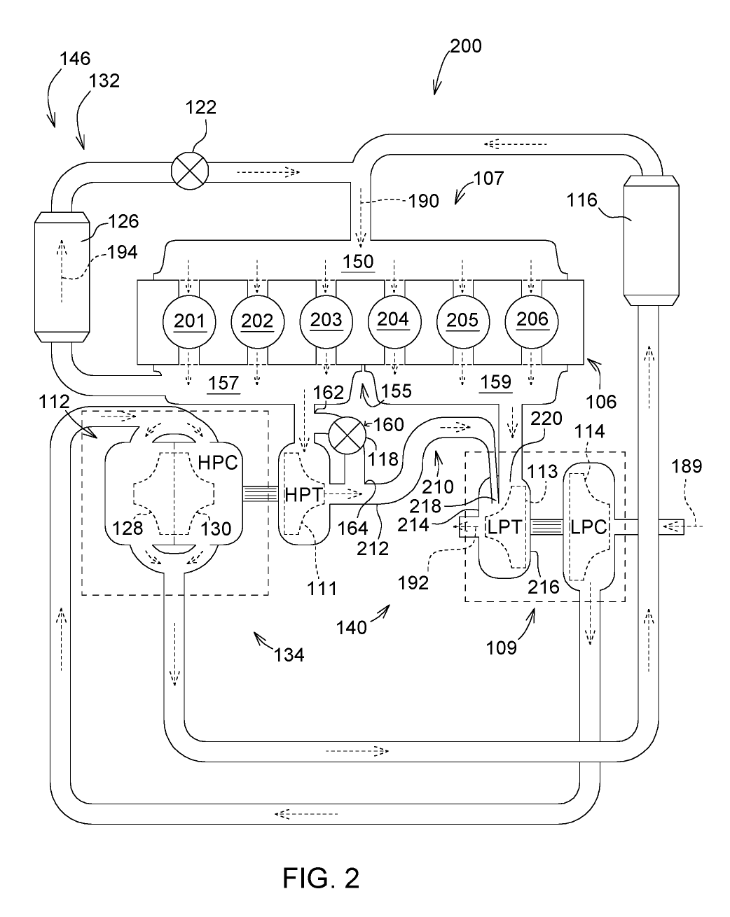

Referring to FIG. 2, there is shown a second power system 200 that includes a bypass passage 210. FIG. 2 is similar to FIG. 1, and thus utilizes many of the same reference numerals. In this embodiment, an inlet 212 of the bypass passage 210 is positioned downstream of the high pressure turbine 111, and an outlet 214 thereof is positioned downstream of the second exhaust manifold 159. By using the bypass passage 210, the exhaust gas flow may have more momentum and more pulse energy for driving the low pressure turbine 113, relative to an arrangement where the exhaust gas must first flow through, and be dampened in, the second exhaust manifold 159, such as shown in FIG. 1.

As shown in the embodiment of the power system in FIG. 2, the low pressure turbine 113 may be disposed in a turbine housing 216, in which the turbine housing 216 includes a first volute 218 and a second volute 220. The first volute 218 may be positioned downstream of the bypass passage 210 (but not downstream of the second exhaust manifold 159), while the second volute 220 may alternatively be positioned downstream of the second exhaust manifold 159 (but not the first exhaust manifold 157). In such embodiments, the outlet 214 may be defined by the turbine housing 216, and be upstream of the first volute 218.

The turbine housing 216 may be an asymmetric turbine housing. For example, the first volute 218 may be relatively small because it receives exhaust gas from the first exhaust manifold 157 (but minus the recirculated exhaust gas), while in contrast the second volute 220 may be relatively large because it receives all of the exhaust gas from the second exhaust manifold 159. By keeping the exhaust gas flows from the first and second exhaust manifolds 157, 159 separate before reaching the low pressure turbine 113, the exhaust gas flow that is out of the second exhaust manifold 159 is more likely to maintain its pulse energy at higher levels for more efficiently driving the low pressure turbocharger 109.

In other embodiments, the outlet 214 may be positioned downstream of the second exhaust manifold 159, but upstream of the low pressure turbine 113 (e.g., in the passage fluidly between the second exhaust manifold 159 and the low pressure turbine 113). In such embodiments, the turbine housing may include only a single volute, instead of two as shown in the illustrated low pressure turbocharger 109.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. A power system, comprising:
an engine;
a first exhaust manifold positioned downstream of the engine;
a second exhaust manifold positioned downstream of the engine; and
a turbine positioned downstream of the first exhaust manifold, but not positioned downstream of the second exhaust manifold.

2. The power system of claim 1, wherein the engine comprises of a set of cylinders, the first exhaust manifold is positioned downstream of a portion of the cylinders in the set, and the second exhaust manifold is positioned downstream of all of the cylinders in the set.

3. The power system of claim 1, wherein the engine comprises of a set of cylinders, and the first exhaust manifold is positioned downstream of a portion of the cylinders in the set, and the second exhaust manifold is positioned downstream of only a remaining portion of the cylinders in the set.

4. The power system of claim 1, further comprising an exhaust gas recirculation passage positioned downstream of the first exhaust manifold, but not downstream of the second exhaust manifold.

5. The power system of claim 1, wherein the second exhaust manifold is positioned downstream of the turbine.

6. The power system of claim 1, further comprising a low pressure turbine, wherein the turbine is a high pressure turbine, the low pressure turbine is positioned downstream of the high pressure turbine and also downstream of the second exhaust manifold.

7. The power system of claim 6, further comprising a wastegate passage and a wastegate valve, wherein:
an inlet of the wastegate passage is positioned downstream of the first exhaust manifold and upstream of the high pressure turbine;
an outlet of the wastegate passage is positioned downstream of the high pressure turbine and upstream of the second exhaust manifold; and
the wastegate valve is positioned downstream of the inlet and upstream of the outlet.

8. The power system of claim 7, wherein the wastegate valve is configured to open when an operating pressure in the first exhaust manifold reaches a threshold pressure.

9. The power system of claim 6, further comprising a high pressure compressor, wherein:
the high pressure turbine is configured to be driven only by exhaust gas exiting the first exhaust manifold;
the high pressure compressor is configured to be driven by the high pressure turbine; and
the high pressure compressor is configured to compress all fresh intake gas that is eventually combusted in the engine.

10. The power system of claim 9, wherein the high pressure compressor comprises a first impeller and a second impeller positioned fluidly parallel relative thereto, and the first impeller and the second impeller and the high pressure turbine are fixed on a shaft so as to rotate in unison.

11. The power system of claim 9, wherein the high pressure turbine is a variable geometry turbine.

12. The power system of claim 9, wherein a pressure ratio of the high pressure turbine is between 2.5 and 4.5, and a simultaneous pressure ratio of the high pressure compressor is between 0.5 and 2.5.

13. The power system of claim 9, wherein a pressure ratio of the high pressure turbine is between 3 and 4, and a simultaneous pressure ratio of the high pressure compressor is between 1 and 2.

14. The power system of claim 9, wherein a pressure ratio of the high pressure turbine is between 50% and 150% higher than a simultaneous pressure ratio of the high pressure compressor.

15. The power system of claim 9, wherein a pressure ratio of the high pressure turbine is between 75% and 125% higher than a simultaneous pressure ratio of the high pressure compressor.

16. The power system of claim 9, wherein a pressure ratio of the high pressure turbine is between 90% and 110% higher than a simultaneous pressure ratio of the high pressure compressor.

17. The power system of claim 6, further comprising a low pressure compressor, wherein:
the low pressure turbine is configured to be driven by exhaust gas exiting the first exhaust manifold and also by exhaust gas exiting the second exhaust manifold;
the low pressure compressor is configured to be driven by the low pressure turbine; and
the low pressure compressor is configured to compress all fresh intake gas that is eventually combusted in the engine.

18. The power system of claim 17, further comprising a bypass passage, an inlet of the bypass passage being positioned downstream of the high pressure turbine, and an outlet of the bypass passage being positioned downstream of the second exhaust manifold.

19. The power system of claim 18, wherein the low pressure turbine is disposed in a turbine housing comprising a first volute and a second volute, the first volute is positioned downstream of the bypass passage, and the second volute is positioned downstream of the second exhaust manifold.
